(19) United States
(12) Patent Application Publication
(10) Pub. No.: US 2004/0065349 A1
(43) Pub. Date: Apr. 8, 2004

(54) Vehicle washing apparatus with improved control

(75) Inventor: Lawrence F. Scheiter JR., Ballwin, MO (US)

Correspondence Address: SENNIGER POWERS LEAVITT AND ROEDEL, ONE METROPOLITAN SQUARE, 16TH FLOOR, ST LOUIS, MO, 63102, US

(73) Assignee: D & S Manufacturing Co., Inc.

(21) Appl. No.: 10/676,223

(22) Filed: Oct. 1, 2003

Related U.S. Application Data
(60) Provisional application No. 60/415,677, filed on Oct. 3, 2002.

(51) Int. Cl. B08B 3/02

(52) U.S. Cl. 134/18; 134/26; 134/36; 134/123; 134/181

(57) ABSTRACT

A vehicle washing apparatus for efficiently cleaning front and rear ends of vehicles. The apparatus includes a carriage which is movable lengthwise of a vehicle. Arch-shaped supports on the carriage support a gantry having spray nozzles for directing liquid toward the vehicle. The gantry is movably mounted relative to the supports such that the carriage and gantry are selectively movable to locate the spray nozzles at positions directly in front, above, and directly behind the vehicle for effective cleaning. The apparatus includes a sensor for determining vehicle length and a controller for moving the carriage and gantry to positions for effective cleaning of the vehicle.

### CROSS-REFERENCE TO RELATED APPLICATION

This application claims the benefit of U.S. Provisional Application No. 60/415,677, filed Oct. 3, 2002.

### BACKGROUND OF THE INVENTION

This invention relates generally to vehicle washing apparatus, and in particular to an automatic brushless car wash system.

A substantial concern when washing vehicles is the ability to satisfactorily clean the grime formed on front and rear ends of vehicles. Front ends accumulate dirt, tar, oil and the like which are thrown upwardly from the road by other vehicles. The same materials are lifted from the road by vehicles' own rear wheels and accumulate on rearward facing surfaces. Existing brushless car wash systems have failed to efficiently clean these critical areas. For example, some systems of the prior art emit a spray toward the front or rear end surfaces from a substantial distance, or at an oblique angle (i.e., non-perpendicular) relative to the surface. That can limit an applied force or otherwise degrade effectiveness such that the system must linger at one position for a longer duration to achieve satisfactory cleaning. As a result, the system consumes increased amounts of water, power, cleaning chemicals, and time. Aggravating this problem is that some systems of the prior art do not control the washing process to correspond with a size of the particular vehicle being washed. When a vehicle is relatively short in length, these systems have sprayers which nevertheless travel a full length of a wash bay, including traveling beyond an end of the vehicle and into an unoccupied portion of the bay.

### SUMMARY OF THE INVENTION

Among the several objects and features of the present invention may be noted the provision of a brushless vehicle washing apparatus to effectively and efficiently clean front and rear ends of vehicles; the provision of such an apparatus which is responsive to a size of each vehicle; the provision of such an apparatus capable of complete automatic vehicle cleaning in a minimum amount of space; and the provision of such an apparatus which is economical to operate.

In general, a vehicle washing apparatus of the present invention comprises a carriage which is movable lengthwise of a vehicle and a gantry supported on the carriage and having spray nozzles for directing liquid toward the vehicle. The gantry is movably mounted relative to the carriage such that the carriage and gantry are selectively movable to locate the spray nozzles at positions directly in front, above, and directly behind the vehicle for effective cleaning.

In another aspect, a method of washing a vehicle of the present invention comprises the steps of directing liquid toward the vehicle from spray nozzles mounted on a gantry, the gantry being supported for movement relative to a carriage which is movable lengthwise of the vehicle. The nozzles are moved, in any sequence, to positions directly in front, above, and directly behind the vehicle by selectively moving the gantry relative to the carriage and moving the carriage relative to the vehicle.

Other objects and features of the present invention will be in part apparent and in part pointed out hereinafter.

### Brief Description of the Drawings

FIG. 1 is a perspective of car wash apparatus according to the present invention;

FIG. 2 is an end view of the apparatus of FIG. 1;

FIG. 3 is a perspective of a movable frame of the apparatus;

FIG. 4 is a schematic of the hydraulic system of the apparatus;

FIGS. 5 and 6 are side elevations illustrating operation of the system to wash a car;

FIG. 7 is a fragmentary perspective showing an interior of a gantry of the apparatus;

FIG. 8 is an exploded perspective of an oscillator assembly;

FIG. 9 is a perspective of a flanged drive wheel of the gantry;

FIGS. 10 and 11 are perspectives of drive wheels of a carriage of the apparatus;

FIG. 12 is a fragmentary perspective of a portion of a support of the apparatus and a track mounted thereon; and

FIG. 13 is a schematic of the control system of the apparatus.

Corresponding reference characters indicate corresponding parts throughout the views of the drawings.

### DETAILED DESCRIPTION OF PREFERRED EMBODIMENTS

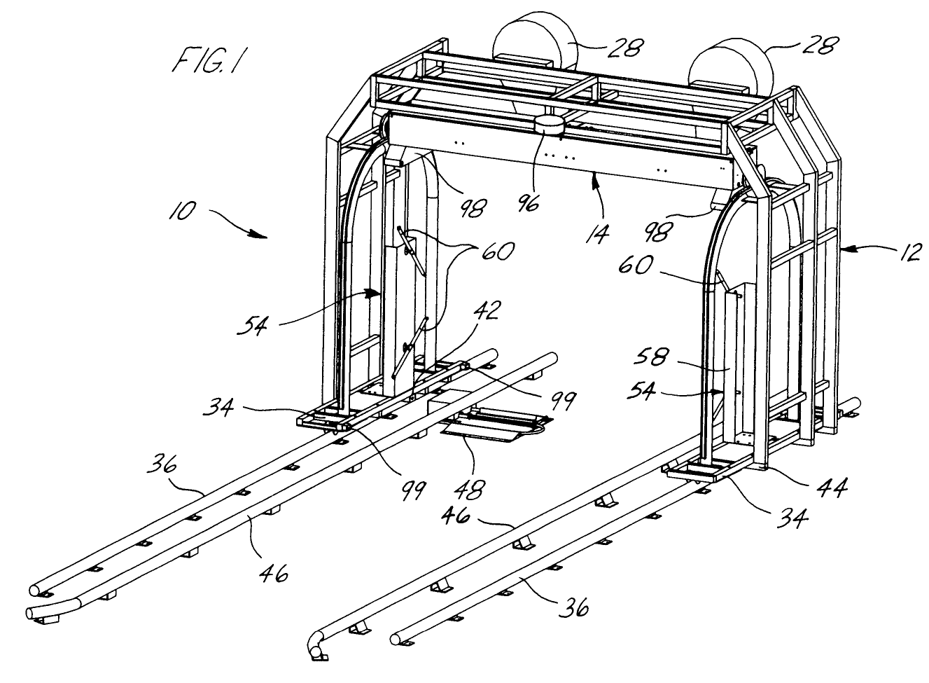

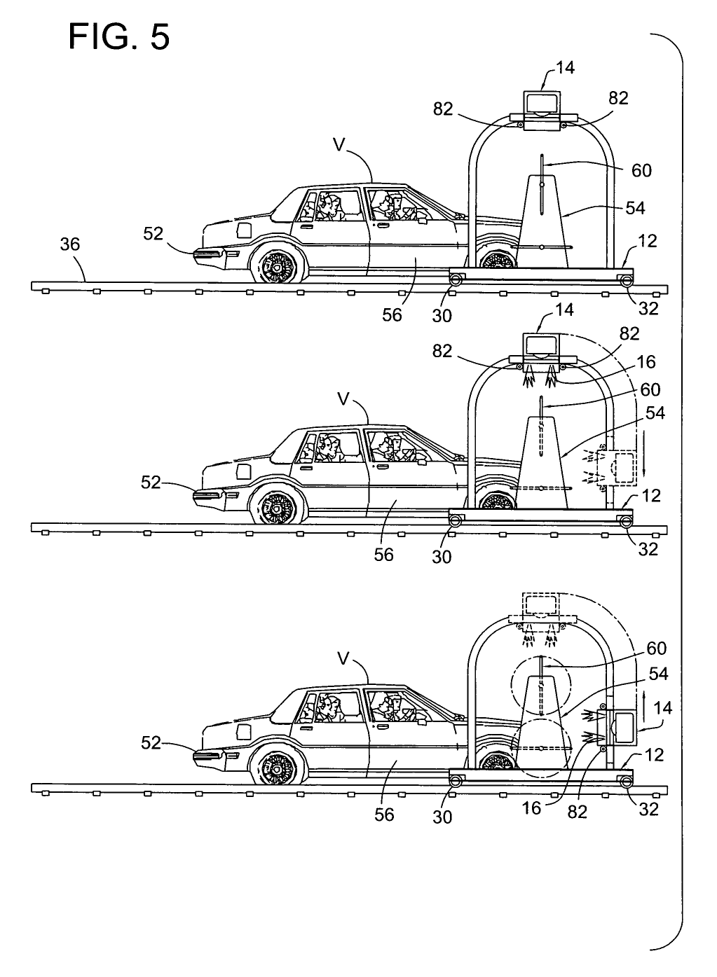

Referring now to the drawings and in particular to FIGS. 1 and 5, apparatus of an automatic brushless car wash system according to the present invention is indicated generally at 10. The apparatus 10 includes a carriage assembly 12 which is movable lengthwise of a vehicle V and a gantry 14 which is supported on the carriage assembly and movable relative to the carriage assembly. The gantry 14 mounts oscillating spray nozzles 16 (FIG. 5) for directing liquid jets toward the vehicle. The apparatus 10 is similar to that apparatus disclosed in co-assigned U.S. Pat. No. 5,161,557, issued Nov. 10, 1992and entitled “Brushless Vehicle Washing Apparatus,” which is hereby incorporated by reference.

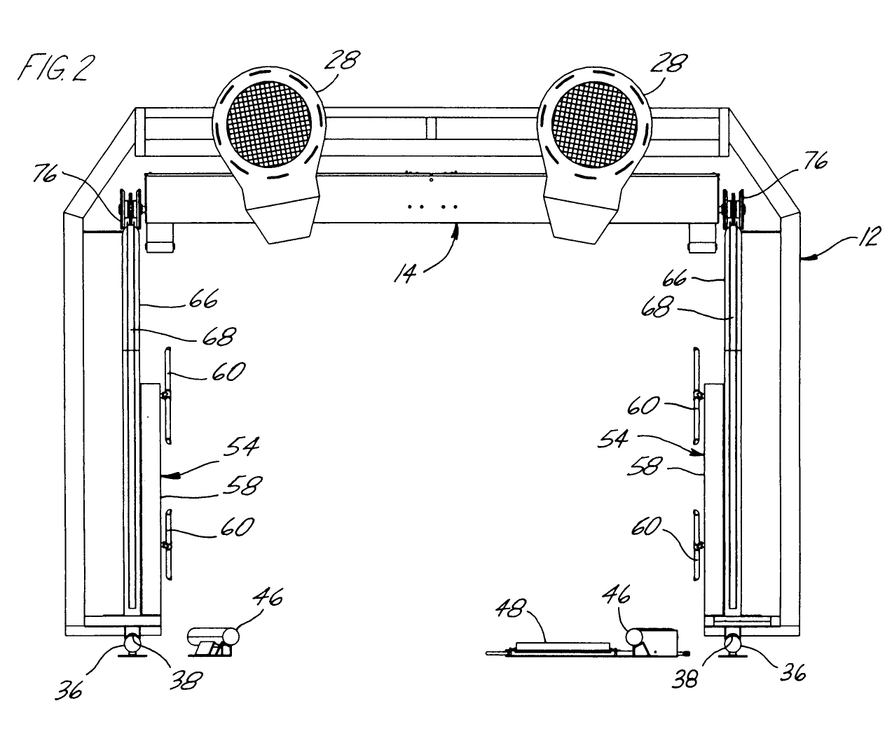

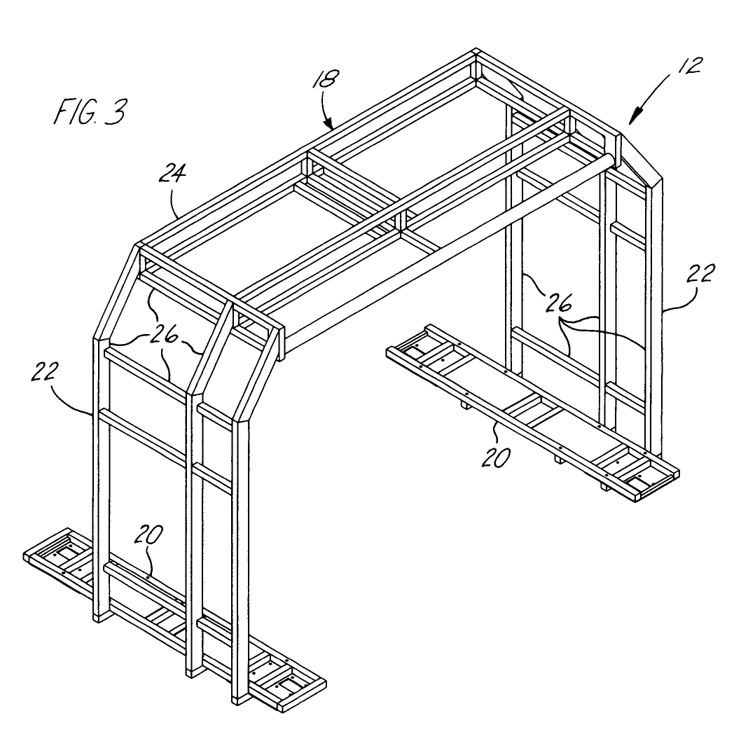

The carriage assembly 12 includes a frame 18 (FIG. 3) formed of sections including two spaced bases 20, an upright section 22 mounted on each base, and an overhead section 24 which extends between the two upright sections. Each section 20, 22, 24 is formed of structural members 26 such as rectangular bar stock connected together as by welding. Each structural member 26 is made of a suitable material which is preferably rigid, strong, and corrosion resistant, such as galvanized steel. The upright and overhead frame sections 22, 24 are each configured for mounting ornamental display panels thereon which conceal the structural members 26. Other accessories may be mounted on the frame sections, such as fan-type dryers 28 (FIGS. 1 and 2) for directing heated air toward the vehicle. The carriage assembly 12 may have other constructions, such as solid (i.e., non-frame type) members and arrangements, without departing from the scope of this invention.

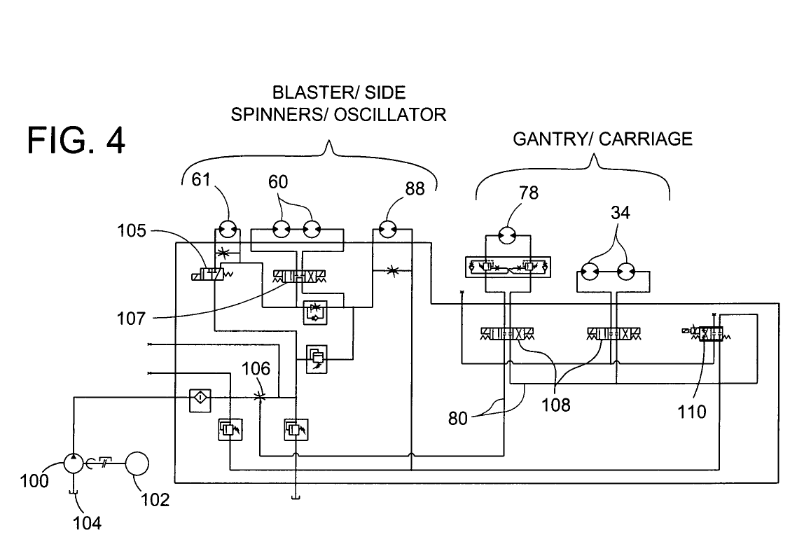

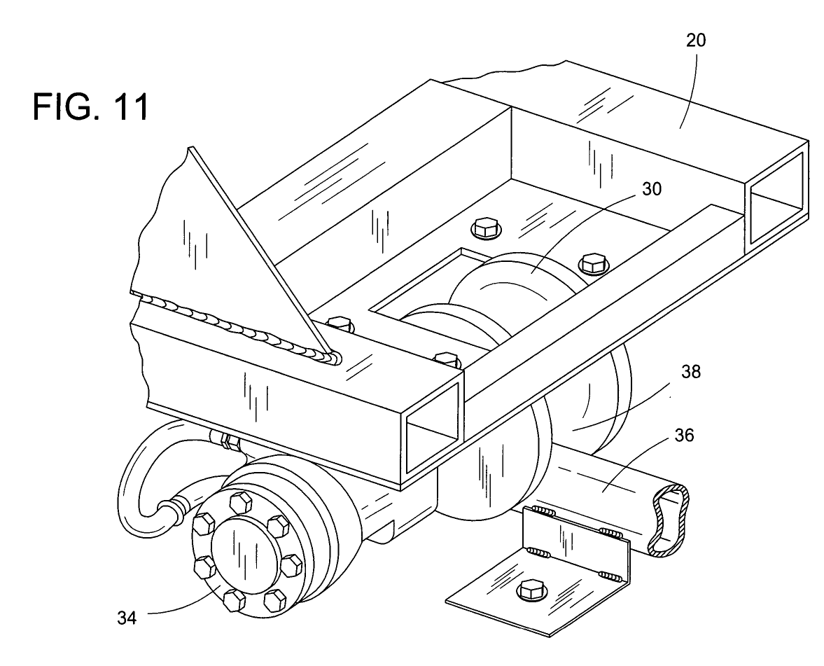

Each base 20 comprises a structural framework which is movably supported by at least two wheels (FIG. 5), including a powered drive wheel 30 and an unpowered wheel 32 which are positioned generally at opposite ends of the base. A conventional hydraulic motor 34 is positioned adjacent each drive wheel 30, as shown in FIG. 11, for powering the drive wheel. Hydraulic fluid lines connect a hydraulic system of the invention (FIG. 4) to the motor 34 for selectively reversible operation of the motor to move the wheels 30, 32 and carriage assembly 12 in either direction.

Two floor-mounted guide tracks 36 (FIGS. 1 and 2) extend parallel along the floor in a longitudinal direction and are configured for engagement by the wheels 30, 32 for guiding the carriage assembly 12. In one embodiment, the tracks 36 are formed of circular tubing made of galvanized steel. Each of the wheels has opposed outer flanges with a semicircular engagement surface 38 (FIG. 2) of size corresponding to a diameter of the tracks 36. Other configurations and materials of the wheels and tracks, including a system without tracks, do not depart from the scope of this invention.

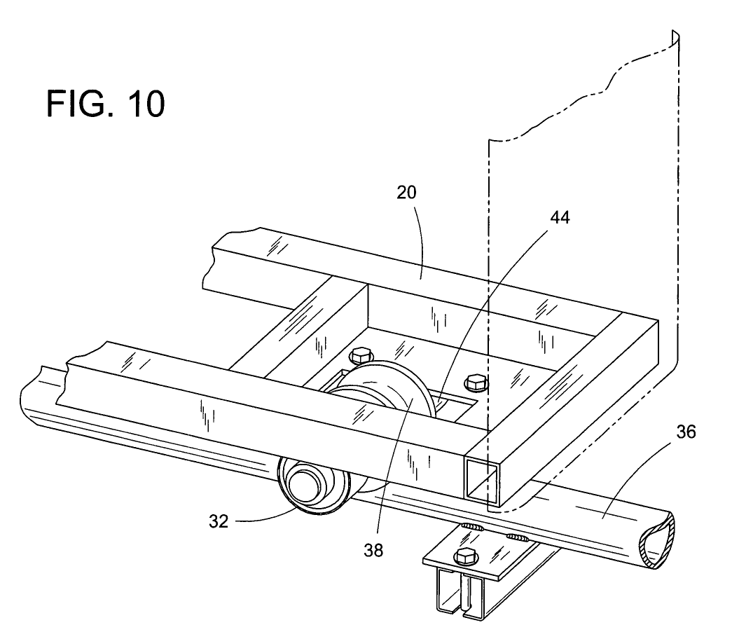

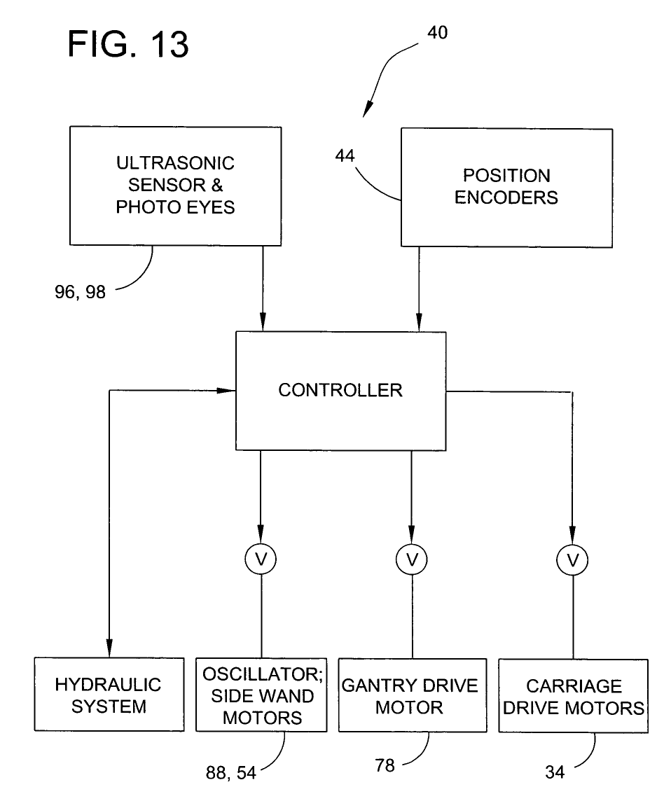

The position of the carriage assembly 12 is controllably monitored by a control system 40 of the invention, as diagrammatically shown in FIG. 13. A home position proximity sensor 42 (FIG. 1) is mounted on the carriage assembly 12 and detects when the carriage assembly is positioned at an initial position relative to the track 36, such as that position shown in FIGS. 1 and 5. An encoder 44 (FIG. 10) is mounted adjacent at least one of the unpowered wheels 32 for monitoring a number and direction of wheel rotations from the home position so that the control system 40 may calculate position of the carriage assembly 12.

Two guide rails 46 (FIGS. 1 and 2) are mounted to the floor in parallel relation, at a position spaced inwardly from the tracks 36. The rails 46 comprise lateral position limits for tires and are used to guide the vehicle V into proper lateral position relative to the apparatus 10 and to protect the apparatus from damage. A treadle 48 is placed on the floor between the guide rails 46 for engagably receiving a tire and defining a proper longitudinal position of the vehicle relative to the apparatus 10. A driver stops the vehicle V at a position where one tire, such as the left front tire, bears on the treadle 48. The treadle 48 is positioned such that the vehicle V is at a location (FIG. 5) where its front and rear ends 50, 52 are generally within a region which is accessible to the apparatus 10 for washing the entire vehicle.

The carriage assembly 12 further includes two opposite side spraying assemblies indicated generally at 54 for cleaning laterally outwardly facing side surfaces 56 of the vehicle V. Each assembly 54 includes a side wall 58 and two vertically spaced rotatable wands 60 having spray nozzles on each tip end. The wands 60 are mounted on each wall 58 for rotation and are driven by hydraulic motors (one per side; not shown). The wands 60 are effective in spraying the entire laterally outwardly facing side surfaces 56 of the vehicle as the carriage assembly 12 moves along the tracks 36 and the wands rotate. An additional spraying bar, shown schematically at 61 in FIG. 4, is located beneath the side wands 60 for emitting liquid jets to wash an underside of the vehicle and/or additional washing of an extreme lower portion of its side surface 56. The spraying bar 61 is commonly known as a “blaster” and is considered as an optional feature of the apparatus 10 for improved cleaning of the underside.

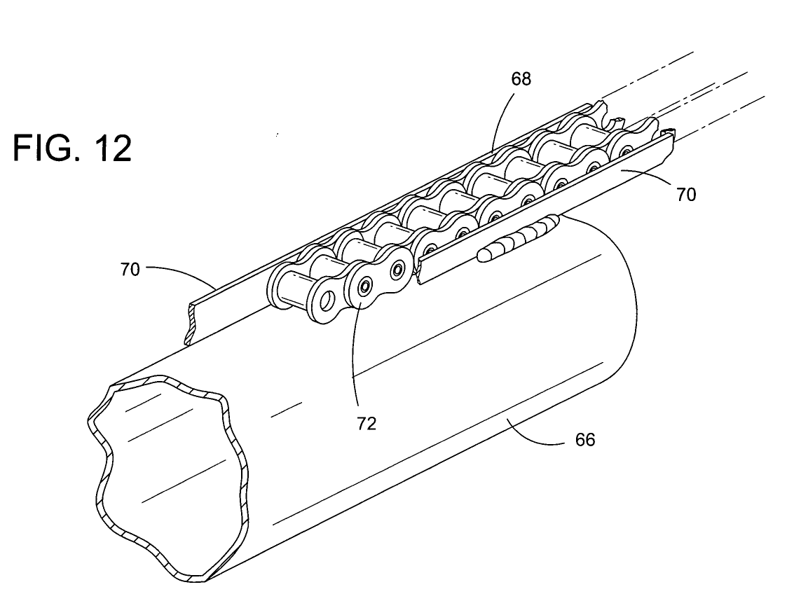

Two opposed supports 66 (FIG. 2) are mounted on the base 20 of the carriage assembly 12 for supporting the gantry 14 and defining a path of travel for the gantry. In one embodiment, each support 66 has an arched contour such as an inverted U-shape. A channel 68 (FIG. 2) is mounted on the outwardly facing side of each support 66 and extends substantially along an entire length of the support. The channel 68 comprises laterally spaced apart metal strips 70 welded on the support 66. Within each channel 68 is received a chain 72 (FIG. 12) defining a track for the gantry 14. The chain 72 is a conventional roller-type chain having spaced links, and it is anchored at each end to an adjustable mount (not shown). The supports 66 may have other alternate shapes and configurations and different provisions for supporting the gantry on a path of travel without departing from the scope of this invention.

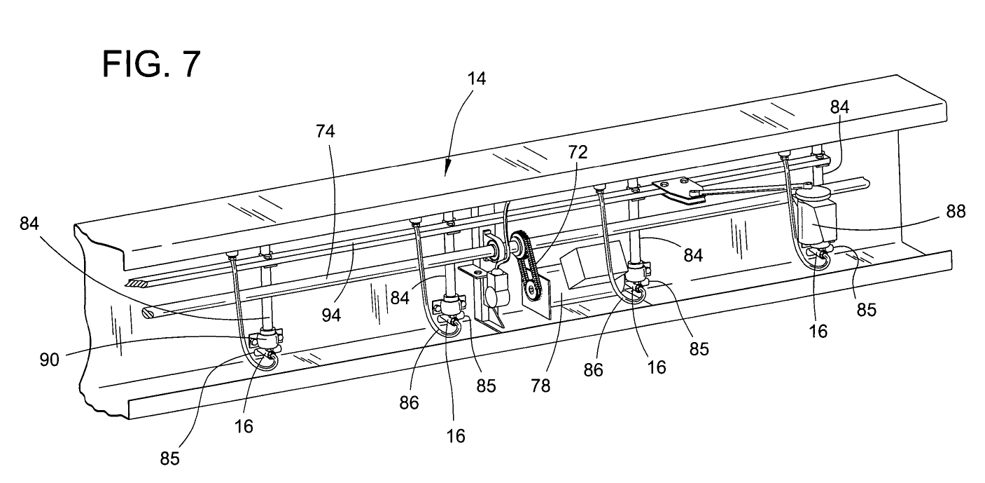

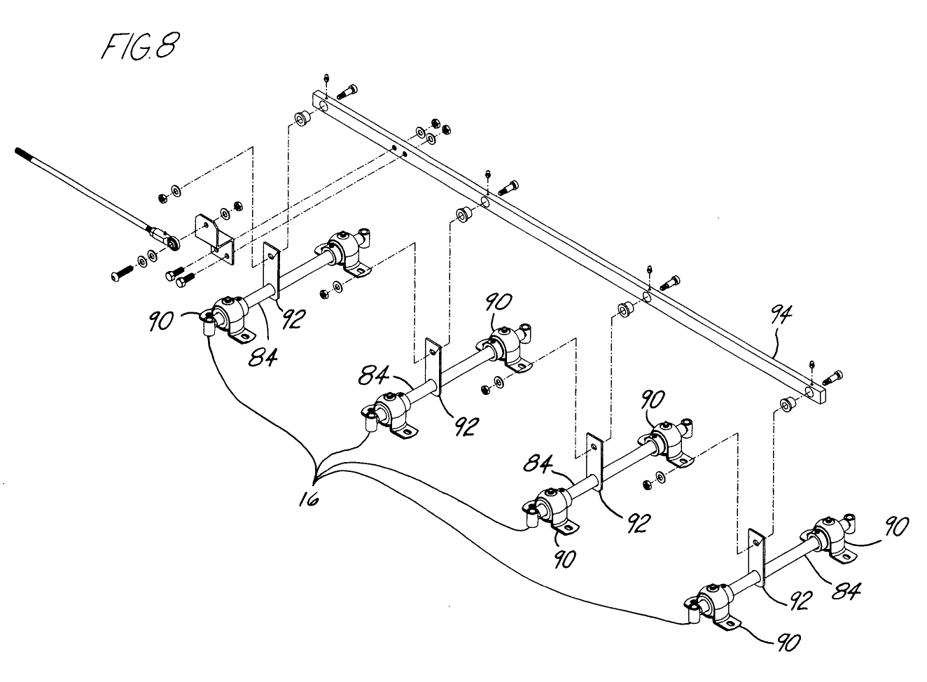

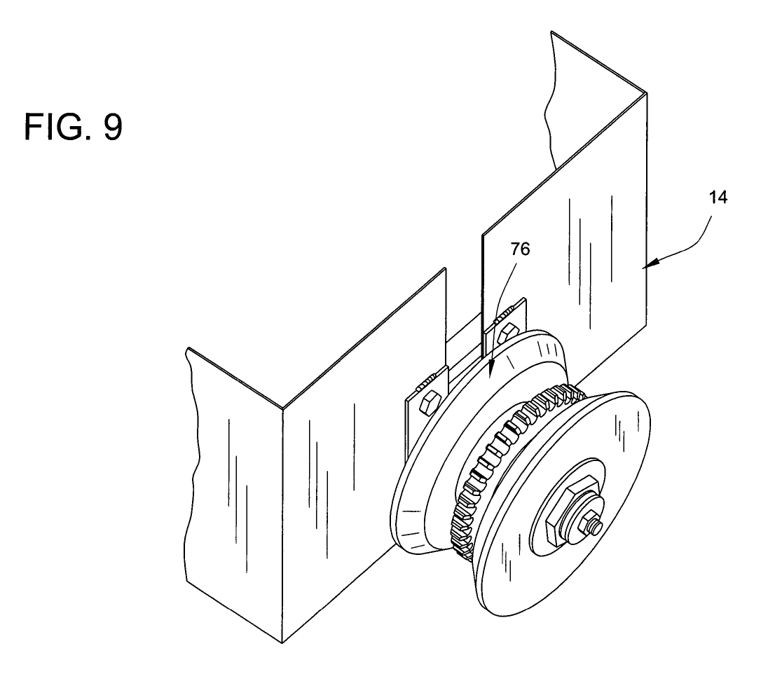

The gantry 14 includes mechanisms for driving the gantry along the chains 72 and for oscillating the spray nozzles 16 to wash the vehicle V. The gantry 14 comprises a generally rectangular shaped housing which mounts the spray nozzles 16 along a side of the gantry facing toward the vehicle. As shown in FIG. 7, the gantry contains a laterally extending shaft 74 mounted for rotation. Flanged drive wheels 76 (FIG. 9) are attached to each end of the shaft 74 and have teeth which are engageable in the links of the chain 72. A first hydraulic motor 78 is mounted in the gantry 14 and operatively connected to the shaft 74 for turning the shaft and thereby moving the gantry along the supports 66. Feed lines 80 (FIG. 4) connect the hydraulic system of the invention to the gantry 14 for selectively reversible operation of the motor 78 to move the gantry in either direction. Retainer wheels 82 (FIG. 5) are attached to the gantry 14 to hold the drive wheels 76 engaged in the links of the chain 72 and to prevent the gantry from falling. The retainer wheels 82 engage the supports 66 on a side opposite from the chain 72 (generally the underside). The eight oscillating spray nozzles 16 are positioned at opposite ends of four rotatable manifolds 84 (FIGS. 7 and 8) in the gantry extending generally transverse of the shaft 74 and configured for directing liquid through elongated slots 85 (FIG. 7). Each manifold 84 is connected by a hose 86 to a liquid supply remote from the apparatus. A second hydraulic motor 88 is operatively connected to each manifold 84 for rotation of the manifolds to thereby oscillate the nozzles 16 and create a scrubbing pattern of the liquid jets on the vehicle. As shown in FIG. 8, each manifold 84 is pivotally mounted in pillow blocks 90 and has a tab 92 projecting outwardly which is pivotally connected to a laterally extending oscillator bar 94 which reciprocates by operative connection to the motor 88.

A home position proximity sensor (not shown) is mounted on the gantry 14 and detects when the gantry is positioned at an initial position relative to the supports 66, such as the overhead position shown in FIGS. 1 and 5. An encoder (not shown) is mounted adjacent at least one of the drive wheels 76 which monitors a number and direction of wheel rotations from the home position so that a controller of the control system 40 may calculate position of the gantry 14. In typical operation, the controller will not permit movement of the carriage assembly 12 unless the gantry 14 is at the home position, thus providing a dual safety feature.

The carriage assembly 12 includes a conventional ultrasonic sensor 96 (FIG. 1) for determining a position of the rear 52 of the vehicle V (the front end 50 being positioned by use of the treadle 48). The sensor 96 is mounted facing downwardly on the overhead section 24. As the carriage assembly 12 moves aft relative to the vehicle V, the sensor 96 determines a position where its downwardly directed ultrasonic waves first strike the floor, indicating that the sensor has passed an entire length of the vehicle. The sensor 96 may be used while the apparatus is in operation to wash the vehicle, and does not require a pre-wash movement of the carriage assembly 12 along the tracks 36 for the purpose of determining a position of the rear end 52 of the vehicle. Accordingly, the time required for such movement may be avoided. Additional photo eyes 99 are positioned on the front and rear carriage as a safety feature, preventing operation of the gantry if the eyes are blocked.

Several photo eyes 98 are positioned on sides of the gantry 14 for ensuring that the gantry does not inadvertently strike the vehicle V. The photo eyes 98 are conventional proximity detectors which send a stop signal to the control system 40 if they should detect approach toward the vehicle.

Referring to FIG. 4, a diagrammatic view of a hydraulic system of the invention includes a power unit having a pump 100, electric motor 102, and supply reservoir 104. The power unit is remote from the apparatus 10 and connected to the apparatus by flexible hydraulic lines (not shown). In the preferred embodiment, the pump 100 has a 6.5 gallon-per-minute (GPM) capacity, the motor 102 is rated at 7.5 horsepower, and the reservoir 104 comprises a 20-gallon tank of a suitable hydraulic oil. Other types and sizes of power units do not depart from the scope of this invention.

The power unit feeds a manifold block (not shown) that is located on the carriage assembly 12, and it includes a filter (not shown) and a priority flow control valve 106 (FIG. 4) through which the oil passes. The control valve 106 sends a portion of the total flow of oil to a blaster/side spinners/oscillator (BSO) leg of the circuit and the remaining flow to a gantry/carriage (GC) leg of the circuit. The BSO leg powers the blaster 61, the side wands 60, and the motor 88 for oscillating nozzles 16. The GC leg powers the motor 78 and 34 for movement of gantry and carriage, respectively. In the preferred embodiment, 1 GPM of oil (adjustable to plus or minus 25%) is routed to the BSO leg and 5.5 GPM is routed to the GC leg.

In one embodiment, the control system 40 directs that only one of the carriage assembly 12 and gantry 14 are in motion at any time. However, a system wherein both carriage assembly and gantry are simultaneously movable does not depart from the scope of this invention.

In the BSO leg, the oil travels to the optional blaster 61 (one hydraulic motor) which is turned on and off by a two-way solenoid valve. Then the oil travels to the side wands 60, powered by two hydraulic motors plumbed in series and operated with a 3-position solenoid directional control valve with pressure to tank in the center position. This allows the oil to flow through this leg unrestricted when the side wands are not in use. The side wands 60 have the capability to run both clockwise and counter-clockwise. After leaving the side spinners the oil goes to the oscillator (one hydraulic motor 88) and then back to tank to complete the BSO leg. A solenoid valve does not control the oscillator motor as it comes on when the power unit is started and turns off when the power unit is turned off. All three functions in the BSO leg have independent speed control via a bleed off. The blaster and the oscillator are of a needle valve construction and the side spinners are of a pressure compensated low control valve construction. In addition all three functions have relief valves for safety in case a problem occurs. Other configurations and circuits do not depart from the scope of this invention.

In the GC leg, the oil enters a parallel circuit to move the gantry along the supports 66 (by one hydraulic motor 78) and the carriage assembly 12 along the tracks 36 (by two hydraulic motors 34 plumbed in series). These two functions are each controlled by a 3-position solenoid directional control valve 108 with all ports clocked in the center position. A proportional throttle valve 110 is incorporated in the pressure port of the leg as a speed control bleed off to tank for both functions. Since the gantry 14 and the carriage assembly 12 do not move at the same time, one proportional throttle valve 110 can be used as a bleed off for both functions. The proportional valve is sent a signal from 0-10 volts DC which in turn directly affects the speed of the gantry and the carriage. (The higher the voltage sent to the proportional valve, the more the bleed off which in turn means the slower the movement.) This enables the circuit to have selectively variable speeds, at a fine resolution, for each of these two functions. The proportional throttle valve 110 is also used to ramp up and down both functions giving a smooth acceleration and deceleration of the movements of the gantry 14 and carriage assembly 12. A relief valve is positioned in the GC leg for safety in case any problems should occur.

Significantly, the system permits an operator to selectively vary speeds of the gantry 14, carriage assembly 12, or both, and such variation may be within a single washing cycle (e.g., pre-soak, high-pressure wash, etc.) or from one type of washing cycle to another.

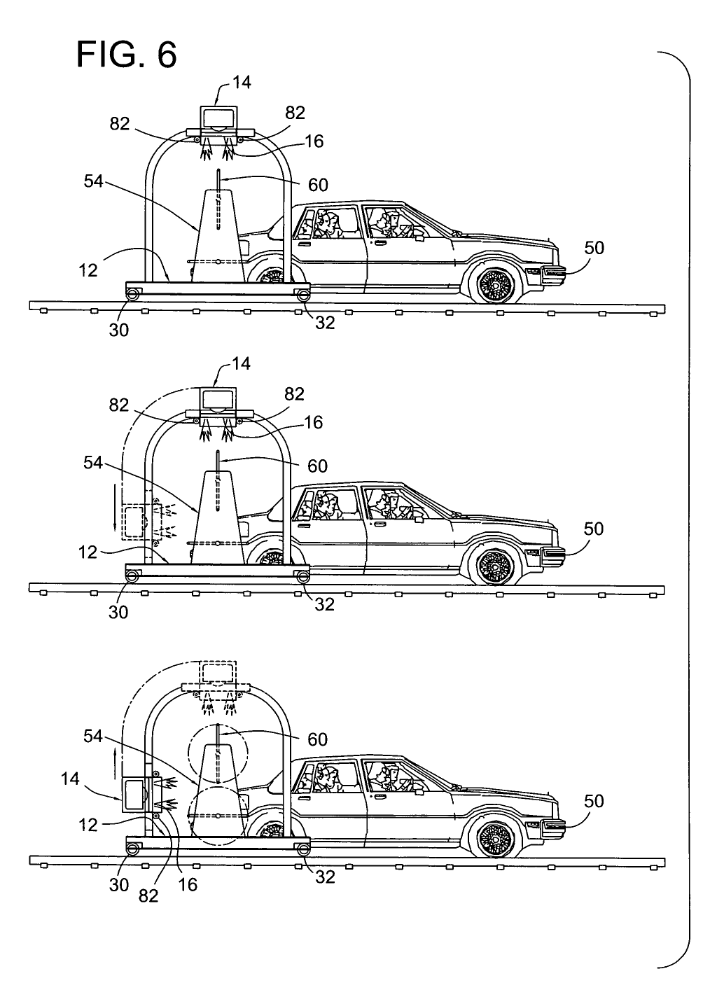

Operation of the apparatus 10 of the present invention is illustrated in FIGS. 5 and 6 with sequential steps undertaken by the control system 40. The vehicle V enters the wash bay and stops with a tire bearing on the treadle 48. The gantry 14, positioned at an overhead location, begins spraying through the eight oscillating spray nozzles 16. The gantry moves along supports 66 to a position directly in front of the vehicle V to wash the front 50. The gantry 14 returns to the home, overhead position and the four side wands 60 activate. The carriage 12 begins moving along tracks 36 toward the rear 52 of the vehicle. As the carriage moves, the spray nozzles 16 and side wands 60 wash top and sides of the vehicle V.

Referring now to the top of FIG. 6, the carriage 12 stops at a position where the sensor 96 indicates is adjacent the rear 52 of the vehicle. The side wands 60 are de-activated, and the gantry 14 begins moving along the supports 66 while the eight oscillating spray nozzles 16 wash the rear 52. After effectively washing the rear, the gantry 14 returns to the overhead position. The carriage 12 begins moving back to its home position. The side wands 60 activate for the return. The entire wash cycle may repeat if desired.

The gantry 14 traverses the supports 66 such that the spray nozzles 16 always face toward the vehicle V, thereby avoiding any need for a complex rotation mechanism as required on some prior art systems to orient the spray nozzles toward the vehicle. Significantly, the apparatus 10 effectively and efficiently cleans front and rear 50, 52 of the vehicle. The oscillating nozzles 16 emit liquid in a scrubbing pattern from a position which is close to the ends and spray directly toward the ends at a substantially perpendicular angle which maximizes applied force. In the preferred embodiment, the spray nozzles 16 are sequentially positioned at a distance from the front and rear ends 50, 52 within a range from about 6 to 16 inches, and more preferably from about 12 to 14 inches. In practice that has quickly removed grime from front and rear ends of vehicles, minimizing time for cleaning and improving throughput of vehicles washed by the apparatus 10. Moreover, the apparatus does not waste any water, chemicals, or power because it senses the length of the vehicle and moves the carriage assembly 12 only that distance necessary to wash all surfaces of the vehicle. The apparatus 10 is compact and economical in construction. The supports 66, being movable, avoid the need to extend a substantial length so as to exceed a maximum vehicle length and may be shorter than non-movable supports of the prior art. All of the movement is driven by a common hydraulic system, including the carriage assembly 12, gantry 14, and oscillating nozzles 16, to minimize complexity and cost.

In view of the above, it will be seen that the several objects of the invention are achieved and other advantageous results obtained.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense.

What is claimed is:

1. A vehicle washing apparatus, comprising:
a carriage which is movable lengthwise of a vehicle; and
a gantry supported on the carriage and having spray nozzles for directing liquid toward the vehicle;
wherein the gantry is movably mounted relative to the carriage such that the carriage and gantry are selectively movable to locate the spray nozzles at positions directly in front, above, and directly behind the vehicle for effective cleaning.

2. A vehicle washing apparatus as set forth in claim 1 further comprising supports on the carriage for supporting the gantry, the supports having an arched shape.

3. A vehicle washing apparatus as set forth in claim 2 wherein each support includes a track engageable by the gantry for directing its movement along the support.

4. A vehicle washing apparatus as set forth in claim 3 wherein the track comprises a chain mounted within a channel.

5. A vehicle washing apparatus as set forth in claim 4 further comprising a flanged drive wheel on the gantry which has teeth engageable with the chain.

6. A vehicle washing apparatus as set forth in claim 3 further comprising a sensor for sensing a position of the vehicle, the carriage being configured for moving from a first position generally at a front of the vehicle where the gantry is positionable directly in front of the vehicle, along a distance corresponding to a length of the vehicle to a second position generally at a rear of the vehicle where the gantry is positionable directly behind the vehicle.

7. A vehicle washing apparatus as set forth in claim 6 wherein the supports and gantry are configured such that when the spray nozzles are at the positions directly in front of and directly behind the vehicle, a spacing between the nozzles and the vehicle is within a range between about 6 and 16 inches.

8. A vehicle washing apparatus as set forth in claim 3 further comprising rotating side sprayers on the carriage for directing liquid toward laterally outwardly facing surfaces of the vehicle.

9. A vehicle washing apparatus as set forth in claim 2 wherein the spray nozzles are maintained in position facing inwardly of the arched-shaped supports and generally toward the vehicle during movement of the gantry relative to the carriage.

10. A vehicle washing apparatus as set forth in claim 9 wherein the spray nozzles are supported on the gantry for oscillatory motion.

11. A vehicle washing apparatus as set forth in claim 1 further comprising a hydraulic system configured to provide independent variable speeds of movement of both the gantry and carriage.

12. A method of washing a vehicle, comprising the steps of:
directing liquid toward the vehicle from spray nozzles mounted on a gantry, the gantry being supported for movement relative to a carriage which is movable lengthwise of the vehicle;
moving the nozzles, in any sequence, to positions directly in front, above, and directly behind the vehicle by selectively moving the gantry relative to the carriage and moving the carriage relative to the vehicle.

13. A method of washing a vehicle as set forth in claim 12 wherein moving the gantry relative to the carriage comprises directing the gantry along an arch-shaped support of the carriage.

14. A method of washing a vehicle as set forth in claim 13 further comprising the step of determining vehicle length for moving the carriage to position for effectively cleaning a rear of the vehicle.
